(19) United States
(12) Patent Application Publication
(10) Pub. No.: US 2003/0197685 A1
(43) Pub. Date: Oct. 23, 2003

(54) Wireless keyboard with a built-in web camera

(76) Inventor: Leland Yi, Seoul (KR)

Correspondence Address: WEISS & MOY PC, 4204 NORTH BROWN AVENUE, SCOTTSDALE, AZ, 85251, US

(21) Appl. No.: 10/061,029

(22) Filed: Apr. 23, 2002

(51) Int. Cl. G09G 5/00

(52) U.S. Cl. 345/168

(57) ABSTRACT

A wireless keyboard with a built-in web camera, which allows a user to input text data and image data without being locally restricted by a wired connection to the computer. According to one preferred embodiment, a wireless keyboard with a built-in web camera is provided, comprising: a first input part for transmitting input key data inputted by a user to a user terminal device, a second input part for transmitting an image signal inputted from the web camera to the user terminal device, a packet generator for receiving the input key data and/or the compressed image signal and producing at least one packet according to a predetermined method, and a transmitter for transmitting the packet to a user terminal device.

### BACKGROUND OF THE INVENTION

1. Field of the Invention

The present invention relates generally to computer keyboards and, more specifically, to a wireless keyboard with a built-in web camera that allows a user to input text data and image data without being locally restricted by a wired connection to the computer.

2. Description of Prior Art

Along with the development of technology, computers are utilized for many purposes, including exchange of specific information between people, or purchasing specific goods. Although there are different types of computers that are manufactured by a variety of companies, all computers have input devices, output devices and processing devices in common. Hereinafter, a conventional keyboard will be described using an accompanying drawing. Since this description is useful to easily understand the present invention, the conventional keyboard will be described in detail.

FIG. 1 is a perspective view of the conventional keyboard. Referring to FIG. 1, the conventional keyboard comprises a plurality of input keys. When a user selects a specific input key, the keyboard detects an electrical response signal corresponding to the specific input key and processes the input key data selection corresponding to the electrical response signal. Also, each input key of the keyboard has a specific operation assigned. Furthermore, the keyboard comprises microprocessors to control digital signals.

Methods for transferring a data selection corresponding to the specific input key selected by the user include the mechanical method, the membranes method, the Reed method, and the capacitive method. The recognition process of the data selection corresponding to the specific input key using those methods is described in brief.

When the user selects a specific input key, the internal circuit for transferring a corresponding digital signal to a microprocessor and the signal transferring process are almost the same for the above methods. However, the main difference between the methods is with respect to how the electrodes, which generate the signal, are contacted.

The mechanical method utilizes a mechanical principle. That is, when a key is pressed, a point of contact is moved down to activate a micro-switch to generate a digital signal before being returned to its original position by a spring. Accordingly, if there is a sound such as a “click” when the user presses a specific key, the mechanical method is used in this keyboard.

If the membranes method is used in the keyboard, then there is a space between the point of contact of the input key and the key plate, with the membrane placed on the key plate. By pressing a specific input key a membrane is selected and, due to the resilience of the membrane, contact between the membrane and the contacting sheet is reached to generate a digital signal.

According to the Reed method, when a specific key is pushed it moves a magnet down to a proper position. There the magnet pulls two points of contacts together, generating a signal. In this method, the point of contact is sealed with a material such as a glass, to insure good contact. However, because of mechanical friction between the two points of contact, the connection will eventually wear out, causing contact problems.

The capacitive method utilizes the principle of charge accumulation, which is used in a capacitor, and, as a result, does not utilize the contact of a conductor, which is utilized in the aforementioned three methods. Accordingly, the capacitive method is a relatively complicated and difficult to use, but still has the advantages of relatively high reliability, relatively good contact and relatively long durability.

When the user selects a specific input key from a plurality of input keys, the method to determine which input key is selected is as follows:

Alphanumeric input keys, such as 1, 2, a, b, @, %, are in four rows and four response circuits are located below the rows of the input keys. The aforementioned response circuit examines more than one thousand times per one second whether or not a signal is inputted. When the user selects a specific input key, the response circuit detects a row signal first and then a column signal corresponding to the row signal. The maximum number of columns is 15 and the response circuit associates the intersection signal with a specific input key.

Accordingly, when the user selects an input key, the signal generated by the input key does not have a special meaning. Whether the generated signal will be used for merely output, for calculation or as a control code is depending on a control program that controls the keyboard. Accordingly, in order to make unambiguous use of the aforementioned codes, ASCII was defined as a standard key code that is used in computers. Therefore, all signals generated in computers are processed on the ground of the value assigned by the program according to ASCII.

When the user selects a specific input key, a code corresponding to the selected input key is transferred to a ‘keyboard controller’. The keyboard controller is located in the keyboard as a form of electrical circuit or on the motherboard. The transferred code is stored in a ‘keyboard buffer’. As a kind of memory, the keyboard buffer is comprised of RAM and temporarily stores necessary data whenever needed. The reason for storing data one by one is that a specific task cannot be directly processed by the use of a signal from an input key.

Hereinafter, the procedure of processing the code will be described with two cases in which the user selects ‘a’ or ‘A’. In the view of the user, selecting ‘a’ and ‘A’ is not very different. When the user selects ‘a’, he just pushes the ‘a’ input key. But when the user selects ‘A’, he has to push the ‘a’ together with the shift input key. Accordingly, whenever the keyboard controller receives a code corresponding to ‘a’, then the keyboard controller checks the keyboard buffer to find if there is a code corresponding fats to any input key that can be selected with the ‘a’ input key, such as the shift input key. However, the processed code is not converted into a scan code directly. A predetermined interrupt request (IRQ) determines whether the processed code is a control code or a mere character code. The predetermined IRQ is fixed by the programmer and cannot be selected or changed by the user. When an interrupt is generated, the scan code is converted into ASCII code and stored in the memory. The scan code represents a value that is transferred from an input key to the keyboard controller and the ASCII code represents a final value that determines whether the scan code is a character code or a control code and is converted into a value for internal processing of the computer. The input data that is processed in the aforementioned steps is utilized in a proper way according to the purpose of the case.

In multimedia, the most fundamental task is to combine computers, electric home appliances and communication devices by means of digitalized information. The computer is excellent at editing, storage and processing of digitalized information, but is weak in processing analog sound and image. Accordingly, multimedia is developed mainly to make full use of the advantages of computers and electric home appliances and to make up for the weak points of each of them.

Hereinafter, a web camera, as a video camera for video conferencing or chatting, which can interface directly with a computer via a USB (Universal Serial Bus) port without video capture board and which can process the inputted image according to the USB interface protocol, is described in brief. A conventional web camera comprises a lens for collecting light reflected from the object, a ccd for converting the light into a charge to be stored temporarily and to produce an electrical signal, an analog-digital converter for converting the electrical signal into a digital signal, an image compensator for converting the data size of the digital signal to a predetermined data size having a reduced resolution and an interface for converting the digital signal according to the USB protocol and for transmitting the digital signal to the computer.

However, a user who wants to use a conventional keyboard and a web camera together has to install them individually, so there is an inconvenience of occupying large space. Further, because a conventional keyboard and a web camera are connected to the computer via wired connection, a user who wants to use them together has the inconvenience that he cannot perform a task at the place where he or she wants to. Further, a conventional keyboard determines which input key is selected by the use of a signal from the intersection of row and column, which corresponds to the input key. If one input key is pushed, another input key cannot be read simultaneously.

### SUMMARY OF THE INVENTION

Accordingly, an object of the present invention is to provide a wireless keyboard with a built-in web camera, wherein the keyboard and the web camera are integrated to help the user efficiently utilize the work space, wherein the web camera can be stored in the keyboard to protect the lens while the web camera is not used, and wherein the web camera can be detached from the keyboard for use in another place.

Another object of the present invention is to provide a wireless keyboard with a built-in web camera, wherein the keyboard and the web camera are connected to a computer via a wireless connection so that the user can move freely.

Still another object of the present invention is to provide a wireless keyboard with a built-in web camera, which comprises an IC chip to produce specific codes corresponding to each input key of the keyboard, so that a task can be perfectly processed even in the case that the user pushes another input key simultaneously.

### BRIEF DESCRIPTION OF THE PREFERRED EMBODIMENTS

In accordance with one embodiment of the present invention, a wireless keyboard with a built-in web camera is disclosed. The wireless keyboard with the build-in web camera comprises, in combination: a first input part for transmitting input key data inputted by a user to a user terminal device; wherein the first input part comprises an input key signal generator, an input key data generator, an input key converter, and an input key transmitter; and a second input part for transmitting an image signal inputted from the web camera to the user terminal device; wherein the second input part comprises an image receiver, an image compressor, an image signal divider, and at least one transmitter.

In accordance with another embodiment of the present invention, a wireless keyboard with built-in web camera is disclosed comprising, in combination: an input key signal generator, an input key data generator, an image receiver, an image compressor, a packet generator, and at least one transmitter.

In accordance with another embodiment of the present invention, a receiving part for receiving data from a wireless keyboard via wireless network is disclosed comprising, in combination: at least one receiver, a packet combiner, a decoder, an image converter, an input key converter, and an integrated transmitter.

In accordance with another embodiment of the present invention, a wireless keyboard with a built-in web camera is disclosed comprising, in combination: a keyboard with a plurality of input keys, a camera coupled to the keyboard for inputting an image signal, a converter for converting the input key data and the image data into a data format suitable for wireless transmission, and a transmitter for transmitting the converted input key data and the converted image signal to a receiving part.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a perspective view of a conventional keyboard.

FIG. 2 is a block diagram of a wireless keyboard with a built-in web camera in accordance with one preferred embodiment of the present invention.

FIG. 3 is a block diagram of the wireless keyboard with the built-in web camera in accordance with another preferred embodiment of the present invention.

FIG. 4 is a block diagram of a receiving part operating with the wireless keyboard and with the built-in web camera according to the present invention.

FIG. 4a is a block diagram of the wireless signal transmission from the wireless keyboard with the built-in web camera to a terminal device.

FIG. 4b is a block diagram of the wireless image signal transmission from the built-in web camera to a terminal device.

FIG. 5a shows a data format for transmitting input key data through a wireless network according to the present invention.

FIG. 5b shows a data format for transmitting an image signal through a wireless network according to the present invention.

FIG. 6 is a perspective view of the wireless keyboard with the built-in web camera according to the present invention.

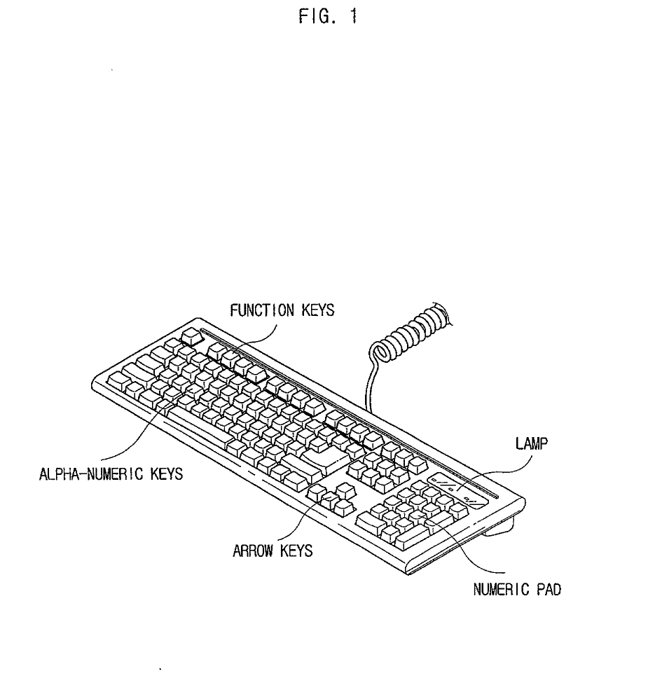

### DETAILED DESCRIPTION OF THE PREFERRED EMBODIMENTS

Hereinafter, the preferred embodiments of the present invention will be described with accompanying drawings.

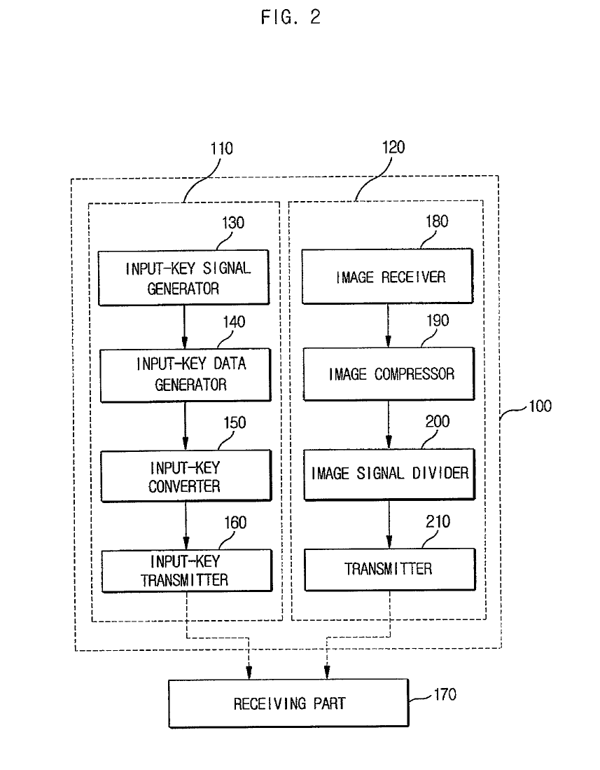

Referring to FIG. 2, a block diagram of a wireless keyboard with a built-in web camera 100 in accordance with one preferred embodiment of the present invention is shown. The wireless keyboard with the built-in web camera 100 generally comprises a first input part 110 and a second input part 120. Any task information inputted in the first input part 110 and/or in the second input part 120 is transferred to a receiving part 170, which is coupled to a terminal device 470 (e.g., computer, set-top box, etc). The first input part 110 for receiving specific input key data selected by a user generally comprises an input key signal generator 130, an input key data generator 140, an input key converter 150, and an input key transmitter 160. The second input part 120 for receiving an image signal inputted from the web camera generally comprises an image receiver 180, an image compressor 190, an image signal divider 200, and a transmitter 210.

The wireless keyboard with the built-in web camera 100 also includes a plurality of input keys comprising an IC chip (e.g., bit code IC) that can produce an individual code corresponding to a specific input key selected by a user. Accordingly, if the user selects a specific input key, the input key signal generator 130 produces a predetermined code using the IC chip. Based on the information of the predetermined code, the input key data generator 140 determines which input key was selected by the user. The determined input key data are then transferred to the input key converter 150. The input key converter 150 converts the input key data received from the input key data generator 140 into a code format that can be transferred to the input key transmitter 160. The input key transmitter 160 transmits the converted input key data to the receiving part 170 packet exchange method can be applied for transmitting the user selected input key data from the first input part 110 to the receiving part 170. In contrast to the conventional circuit exchange method wherein an electrical line that connects a transmitter and a receiving part is occupied until the end of the data transmission, in the packet exchange method the specific information that needs to be transferred is divided into several packets and immediately after the transmission of a packet, the line is open. By using the packet exchange method, the efficiency of the line can be improved and a larger amount of information can be exchanged. In this case, the information for the discriminating receiver must be included in the packet. If the input key data inputted in the first input part 110 is transferred as a packet, a predetermined identification code representing what kind of task should be processed is assigned to the header of each packet.

Still referring to FIG. 2, in the case that the user operates the second input part 120 for video chatting or video conferencing, the image receiver 180 receives a corresponding image signal and then transmits the image signal to the image compressor 190. The image compressor 190 adjusts and compresses the image signal received from the image receiver 180, and therefore reduces the size of the image signal. As a result, the amount of data to be transmitted by transmitter 210 is reduced. The image compressor 190 also adjusts the brightness and the colors of the image signal using a reference value extracted from the analysis of the image signal. The reference value is obtained from a histogram of brightness value of the entire image signal and by extracting several peak values. The brightness of the colors included in the image signal is processed by each color; however, a standard adjustment of the entire brightness can be applied without change. The image compressor 190 adjusts the brightness of the image so that it is entirely improved and has a clear outline. Also, through the color adjustment in the image compressor 190, there will be a separation between the colors resulting in clear texture and characteristics. The image compressor 190 also adjusts the contrast. The adjusted image signal is then compressed in the image compressor 190. The compression method executed in the image compressor 190 converts the original image signal into an image signal according to the JPEG format. The compression method further comprises the step of adding an error detection code for detecting “errors” which occurred in the step of wireless transmission.

Also, in the case that the transmission method is RF transmission, MPEG-4 can be utilized additionally allowing streaming transmission. MPEG (Moving Picture Expert Group)-4 is a second generation encoding method. In contrast to a first generation encoding method, which processed pixels directly, the second generation encoding method recognizes the contents of the image data to divide the image according to the different characteristics, and then applies proper encoding algorithm to the divided image or compresses characteristics extracted from the divided image. The second generation encoding method can be called a ‘smart encoding method’ because the method analyzes and recognizes the contents of the image first of all. There are several representatives for the second generation encoding method including object based coding, model based coding, segmentation based coding, and fractal coding.

Still referring to FIG. 2, after the adjustment and the compression of the image signal are completed, the image compressor 190 divides the compressed image signal into one or more packets, assigns a predetermined identification code and then transmits the packet to the image signal divider 200 (packet exchange method). Depending on the size of the image signal, the number of packets is determined in the early step of compression. The image signal divider 200 recognizes the size of the image signal received from the image compressor 190, divides the image by a predetermined size if it is impossible to transmit the image signal by only one transmitter, and then transmits several divided images to a plurality of transmitters 210. The transmitter 210 transmits the image signal received from the image signal divider 200 to the receiving part 170.

As aforementioned, IR transmission method or RF transmission method can be applied as a method for transmitting data inputted from the wireless keyboard with the built-in web camera 100 to the receiving part 170 to execute a task corresponding to the data in the terminal device 470.

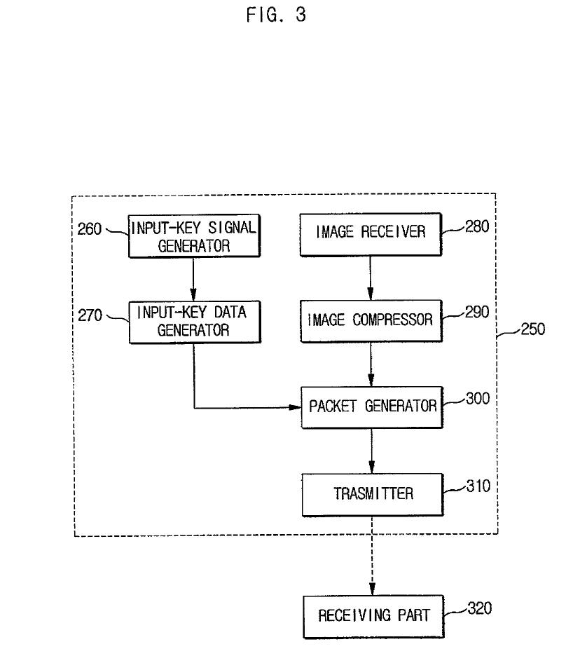

Referring to FIG. 3, a block diagram of the wireless keyboard with the built-in web camera in accordance with another preferred embodiment of the present invention is shown. The wireless keyboard with the built-in web camera 250 generally comprises an input key signal generator 260, an input key data generator 270, an image receiver 280, an image compressor 290, a packet generator 300 and a transmitter 310. Any task information inputted by the user in the wireless keyboard with the built-in web camera 250 is transmitted through the transmitter 310 to the receiving part 320 that is coupled to the terminal device 470 (e.g., computer, set-top box, etc).

The wireless keyboard with the built-in web camera 250 also includes a plurality of input keys comprising an IC chip (e.g., bit code IC) that can produce an individual code corresponding to a specific input key selected by a user. Accordingly, if the user selects a specific input key, the input key signal generator 260 produces a predetermined code using the IC chip. Based on the information of the predetermined code, the input key data generator 270 determines which input key was selected by the user. The determined input key data are then transferred to the packet generator 300. Also, in the case that a user wants to use video chatting or video conferencing, the image receiving part 280 receives an image signal and then transmits the received image signal to the image compressor 290. The image compressor 290 adjusts and compresses the image signal received from the image receiver 280. Since the adjustment and the compression executed in the image compressor 290 were already described using FIG. 2, the description on the adjustment and the compression is omitted here.

Still referring to FIG. 3, after the adjustment and the compression of the image signal are completed, the image compressor 290 divides the compressed image signal into one or more packets, assigns a predetermined identification code and then transmits the packet to the packet generator 300. Depending on the size of the image signal, the number of packets is determined in the early step of compression. The packet generator 300 composes a packet with the input key data received from the input key data generator 270 and recognizes the size of the image signal received from the image compressor 290, divides the image by a predetermined size if it is impossible to transmit the image signal by only one transmitter, and then transmits several divided images to a plurality of transmitters 310. The transmitter 310 transmits the image signal received from the packet generator 300 to the receiving part 320.

The packet transferred from the wireless keyboard with the built-in web camera 250 to the receiving part 320 comprises a predetermined identification code representing what kind of task should be processed based on the corresponding information.

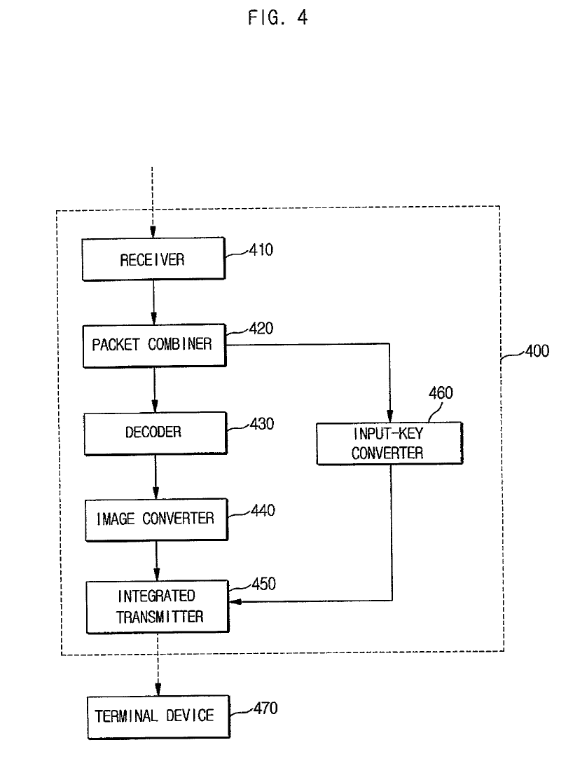

Referring now to FIG. 4, a block diagram of a receiving part operating with the wireless keyboard with the built-in web camera according to the present invention is shown. The receiving part 400 generally comprises a receiver 410, a packet combiner 420, a decoder 430, an image converter 440, an integrated transmitter 450 and an input key converter 460. The data received in the receiving part 400 is transmitted through the integrated transmitter 450 to the terminal device 470 (e.g., computer, set-top box, etc).

At least one receiver 410 receives input key data or an image signal transferred from at least one of the transmitters 160, 210, and 310 by RF transmission or IF transmission and transmits them to the packet combiner 420. The packet combiner 420 combines the data received from the receiver 410 to compose a complete packet. The input key data and the image signal are separately composed to a complete packet. Then the packet combiner 420 transmits the image signal composed into a complete packet to the decoder 430 and the input key data composed into a complete packet to the input key converter 460 using the identification codes, which are included in the packet. The decoder 430 decodes the image signal compressed in the compressor 190 (FIG. 2), 290 (FIG. 3) and transmits the decoded image signal to the image converter 440. The image converter 440 then converts the decoded image signal into a data format suitable for a predetermined transmission protocol (e.g., USB) and transmits the converted image signal to the integrated transmitter 450. The image converter 440 also determines the device that inputs the image signal and reports this information to the terminal device 470.

In one preferred embodiment, the integrated transmitter 450 is a hub for connecting a plurality of devices and transmitting the converted image signal received from the image converter 440 and the converted data received from the input key converter 460 to the terminal device 470, as shown in FIG. 4a. A hub is a device for connecting several ports to one port. In the case of using a hub obeying the USB transmission protocol, the hub can connect a maximum of 127 devices.

In another preferred embodiment, the integrated transmitter 450 is a USB engine that is connected with the terminal device 470 through a USB port, as shown in FIG. 4b.

Referring again to FIG. 4, the packet combiner 420 transmits the packet with the input key data to the input key converter 460 using an identification code included in the packet. The input key converter 460 converts the input key data composed as a complete packet into a data format suitable for a predetermined transmission protocol (e.g., USB) and transmits the input key data to the integrated transmitter 450. In the case of the input key data, a step for compressing and decoding is not needed as for the image signal.

Now referring to FIGS. 2, 3 and 4, a method for synchronizing a packet during transmission from the wireless keyboard with the built-in web camera 100 (in FIG. 2), 250 (in FIG. 3) to the receiving part 170 (in FIG. 2), 320 (in FIG. 3) is described. Generally a packet transmission method is utilized for high-speed data transmission in IR transmission. If the data is not received orderly in the receiver when using this method, it is impossible to reproduce the complete data. In order to solve the above-mentioned problem, a synchronizing method can be applied. Since this method uses the order of packets instead of their transmission speed, the receiving part 170 (in FIG. 2), 320 (in FIG. 3) needs to receive predetermined code data (e.g., packet ID). An inherent code data (e.g., packet ID) will be assigned to each packet after the step of compressing is completed in the image compressor 190 (in FIG. 2) or 290 (in FIG. 3). Then the data is transferred to the transmitter 210 (in FIG. 2) or 310 (in FIG. 3) via the image signal divider 200 (in FIG. 2) or 300 (in FIG. 3) and transmitted to the receiving part 170 (in FIG. 2) or 320 (in FIG. 3). Here, the data are received by at least one receiver 410 and are decoded by the decoder 430 after passing through the packet combiner 420.

Also, if it is necessary to transfer the data to a plurality of transmitters, the data has to include a transmitter identification (e.g., a transmitter number). The transmitter identification will be assigned when the image divider 200 divides the data to be transmitted to each transmitter 210. The data then are reproduced and transferred to the user terminal device 470 (e.g., computer, set-top box) through the image converter 440 and the integrated transmitter 450.

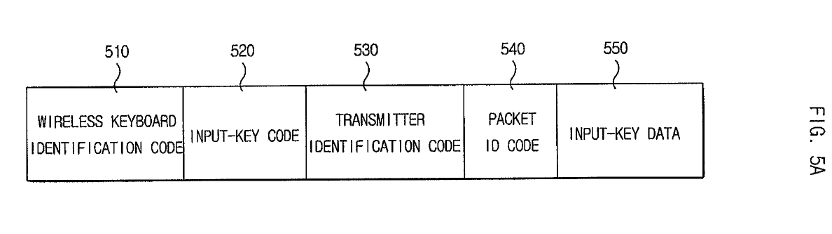

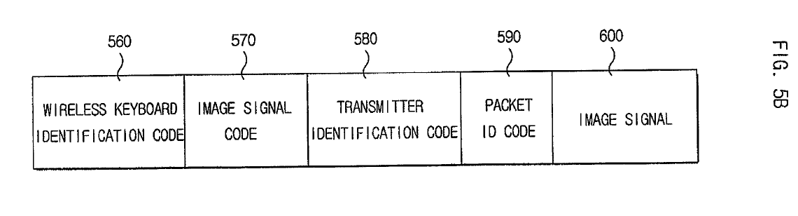

Referring now to FIG. 5a, a data format for transmitting input key data through a wireless network according to the present invention is shown. The data format for transmitting input key data through a wireless network comprises a wireless keyboard identification code data field 510, an input key code data field 520, a transmitter identification code data field 530, a packet ID code data field 540 and an input key data field 550. The wireless keyboard identification code data field 510 is a field where data transmitted from the wireless keyboard 100 (in FIG. 2) or 250 (in FIG. 3) are selectively received. The input key code data field 520 is a field for task data. These packet data transmitted from the wireless keyboard 100 (in FIG. 2) or 250 (in FIG. 3) are input key data corresponding to a combination of more than two input keys or a special command. The transmitter identification code data field 530 is a field representing which transmitter of the wireless keyboard 100 (in FIG. 2) or 250 (in FIG. 3) is utilized to transmit user task data (e.g., an input of input key data, an input of image signal) to the receiving part 170 (in FIG. 2) or 320 (in FIG. 3). The packet ID code data field 540 is a field for the packet ID code. The packet ID code will be assigned to each packet in the case that the user task data are divided into at least two packets. If the data are divided, the receiving part 170 (in FIG. 2) or 320 (in FIG. 3) transforms the divided data into complete data using the transmitter identification code data field 530 and the packet ID data field 540. The input key data field 550 is a field for the input key data that has been converted into a proper data format for wireless transmission.

Referring now to FIG. 5b, a data format for transmitting an image signal through a wireless network according to the present invention is shown. The data format for transmitting an image signal through a wireless network generally comprises a wireless keyboard identification code data field 560, an image signal code data field 570, a transmitter identification code data field 580, a packet ID code data field 590 and an image signal field 600. The description of the wireless keyboard identification code data field 560, the transmitter identification code data field 580, and the packet ID code data field 590 is the same as described above. The image signal code data field 570 is a field describing if the packet data transmitted from the wireless keyboard are inputted through the web camera coupled with the wireless keyboard. The image signal field 600 is a field for image signals that have been converted into a proper data format for wireless transmission.

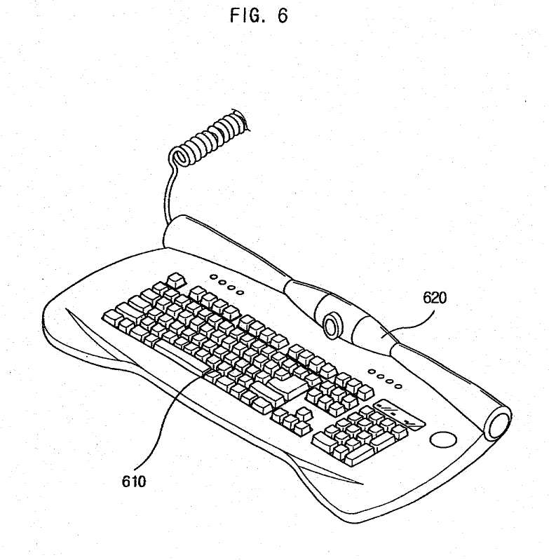

Referring now to FIG. 6, a perspective view of the wireless keyboard with the built-in web camera according to the present invention is shown. The wireless keyboard with the built-in web camera generally comprises an input key part 610 and a web camera part 620. As aforementioned, the input key part 610 comprises a plurality of input keys, so the user can input specific characters or symbols. The web camera part 620 is an input device for image signals that can be used for video chatting or video conferencing. The lens included in the web camera part 620 can be controlled in an up, down, right, and left direction. Furthermore, the web camera part 620 can be stored in the keyboard to protect the lens while the web camera is not used. The web camera part 620 can also be detached from the keyboard. This way the user can move the web camera part 620 to a convenient place of his or her choice. As aforementioned, the input key part 610 and the web camera part 620 are implemented as separate devices, so each can operate as an independent device after being recognized.

Furthermore, a microphone or a point device (e.g., mouse) can be coupled to the wireless keyboard with a built-in web camera. The user voice data inputted through the microphone can be transmitted to the receiving part by IR transmission or RF transmission. The microphone can be included in the wireless keyboard or coupled to the wireless keyboard by a coupling device (e.g., jack).

While the invention has been particularly shown and described with reference to preferred embodiments thereof, it will be understood by those skilled in the art that the foregoing and other changes in form and details may be made therein without departing from the spirit and scope of the invention.

What is claimed is:

1. A wireless keyboard with a built-in web camera comprising, in combination:
a first input part for transmitting input key data inputted by a user to a user terminal device;
wherein said first input part comprises, in combination:
(a) an input key signal generator for producing a scan code corresponding to an input key selected by said user;
(b) an input key data generator for producing said input key data corresponding to said scan code;
(c) an input key converter for converting said input key data into a predetermined code format; and
(d) an input key transmitter for transmitting said converted input key data to said user terminal device via a wireless network; and
a second input part for transmitting an image signal inputted from said web camera to said user terminal device;
wherein said second input part comprises, in combination:
(e) an image receiver for receiving said image signal;
(f) an image compressor for adjusting and compressing said image signal;
(g) an image signal divider for dividing said compressed image signal, based on data size of said compressed image signal and a predetermined data size for transmission, into a proper size based on said predetermined data size; and
(h) at least one transmitter for transmitting said divided image signal to said user terminal device.

2. The wireless keyboard as stated in claim 1, wherein said user terminal device comprises at least one selected from a group consisting of a computer and a set-top box.

3. The wireless keyboard as stated in claim 1, wherein at least one selected from a group consisting of said input key data and said image signal is transmitted to said user terminal device through a wireless transmission.

4. The wireless keyboard as stated in claim 3, wherein said wireless transmission comprises at least one selected from a group consisting of IR transmission and RF transmission.

5. The wireless keyboard as stated in claim 1, wherein said input key data and said image signal are transmitted to said user terminal device with a predetermined identification code added.

6. The wireless keyboard as stated in claim 1, wherein said image compressor adjusts brightness and color of said image signal using a reference value extracted from an analysis of said image signal.

7. The wireless keyboard as stated in claim 1, wherein said image compressor compresses said image signal adding an error detection code for detecting errors which occurred in said step of wireless transmission.

8. A wireless keyboard with a built-in web camera comprising, in combination:
an input key signal generator for producing a scan code corresponding to an input key selected by a user;
an input key data generator for producing said input key data corresponding to said scan code;
an image receiver for receiving an image signal;
an image compressor for adjusting and compressing said image signal;
a packet generator for receiving at least one selected from a group consisting of said input key data and said compressed image signal and producing at least one packet according to a predetermined method; and
at least one transmitter for transmitting said packet to a user terminal device.

9. A receiving part for receiving data from a wireless keyboard via a wireless network comprising, in combination:
at least one receiver for receiving at least one selected from a group consisting of said input key data and said image signal which are transmitted from at least one transmitter embedded in said wireless keyboard;
a packet combiner for determining whether said data received by said receiver are said input key data or said image signal and combining said data as a complete packet;
a decoder for reproducing said data, if said data are compressed image signals;
an image converter for converting said reproduced image signal into a data format suitable for a predetermined transmission protocol;
an input key converter for converting said data into a data format suitable for a predetermined transmission protocol, if said data are said input key data; and
an integrated transmitter for transmitting at least one selected from a group consisting of said converted image signal and said converted input key data to a user terminal device.

10. The receiving part as stated in claim 9, wherein said image converter determines said input device of said image signal and reports said input device to said user terminal device while converting said image signal.

11. The receiving part as stated in claim 9, wherein said wireless transmission comprises at least one selected from a group consisting of IR transmission and RF transmission.

12. A wireless keyboard with a plurality of input keys comprising, in combination:
an input key signal generator for producing a scan code corresponding to an input key selected by said user;
an input key data generator for producing said input key data corresponding to said scan code;
an input key converter for converting said input key data into a predetermined code format; and
an input key transmitter for transmitting said converted input key data to said user terminal device via wireless network.

13. A wireless keyboard with a built-in web camera comprising, in combination:
a keyboard with a plurality of input keys;
a camera coupled to said keyboard for inputting an image signal;
a converter for converting said input key data inputted from said keyboard and said image data inputted from said camera into a data format suitable for wireless transmission; and
a transmitter for transmitting said converted input key data and said converted image signal to a receiving part.

14. The wireless keyboard as stated in claim 13, wherein said camera can be separated from said wireless keyboard and be used separately.
